(19) United States
(12) Patent Application Publication
(10) Pub. No.: US 2026/0088540 A1
(43) Pub. Date: Mar. 26, 2026

(54) NETWORK DEVICE HAVING PORT CONNECTORS WITH FLEX CIRCUITS

(71) Applicant: Arista Networks, Inc., Santa Clara, CA (US)

(72) Inventors: Elliott Benard Van Hartingsveldt, San Jose, CA (US); Youngbae Park, Milpitas, CA (US)

(21) Appl. No.: 18/896,730

(22) Filed: Sep. 25, 2024

(51) Int. Cl. H01R 12/79; H01R 12/71

(52) U.S. Cl. CPC H01R 12/79; H01R 12/716

(57) ABSTRACT

A network device or a system can include a host printed circuit board, a board connector disposed on a surface of the host printed circuit board, a port connector disposed on the surface of the host printed circuit board, and a flex circuit having a first end coupled to the board connector and having a second end that extends into the port connector. The port connector is configured to receive an external connector module. The flex circuit can be directly coupled to corresponding contacts of the external connector module or can be coupled to the contacts through contact beams or a compression socket.

### BACKGROUND

A network device can include one or more processors mounted on a printed circuit board. The one or more processors can be connected to corresponding port connectors of the network device. It can be challenging to connect the one or more processors to the port connectors.

Conventional mechanisms for connecting a processor to various port connectors in a network device often exhibit poor signal loss behavior. It is within such context that the embodiments herein arise.

### BRIEF DESCRIPTION OF THE DRAWINGS

FIG. 1 is a diagram of an illustrative system having interconnected network devices in accordance with some embodiments.

FIG. 2 is a side view of an illustrative network device having port connectors coupled to corresponding board connectors via respective flex circuits in accordance with some embodiments.

FIG. 3 is a side view of an illustrative port connector electrically coupled to corresponding flex circuits via respective contact beams in accordance with some embodiments.

FIG. 4 is a bottom perspective view of illustrative contact beams coupled to a flex circuit of the type shown in FIG. 3 in accordance with some embodiments.

FIG. 5 is a top (plan) view showing illustrative interconnect routing paths on a flex circuit in accordance with some embodiments.

FIG. 6 is a side view of an illustrative flex circuit assembly configured to directly contact pads of a port connector in accordance with some embodiments.

FIG. 7 is a bottom perspective view of an illustrative flex circuit assembly of the type shown in FIG. 6 in accordance with some embodiments.

FIG. 8 is a side view of an illustrative port connector having a movable connector portion coupled to a flex circuit and configured to movably contact a connector module via a compression socket in accordance with some embodiments.

FIG. 9A is a top (plan) view of illustrative signal and ground contacts arranged in a rectangular pattern in accordance with some embodiments.

FIG. 9B is a top (plan) view of illustrative signal and ground contacts arranged in a hexagonal pattern in accordance with some embodiments.

FIG. 10 is a side view of an illustrative port connector having a compression socket configured to receive a corresponding connector module that is inserted into the port connector in a direction parallel to a surface normal of the compression socket in accordance with some embodiments.

FIG. 11 is a diagram showing illustrative hardware components within a data processing system in accordance with some embodiments.

### DETAILED DESCRIPTION

The present embodiments provide a network device that includes a main (host) printed circuit board (PCB), one or more processors mounted on the host PCB, and port connectors disposed on the host PCB. Additional port connectors can optionally be stacked on the board-mounted port connectors. The port connectors can be configured to receive pluggable modules. The port connectors can be coupled to flex circuits, sometimes referred to as flexible PCBs or flexible substrates. Each flex circuit may have a first end coupled to a port connector and a second end coupled to a board connector mounted on the host PCB. The board connector, sometimes referred to as the host board connector, can be any type of board-mounted connection. The board connector can be positioned at some location on the host PCB away from the port connector to provide flexible routing and placement flexibility.

In accordance with an embodiment, the first end of the flex circuit may be coupled to a polymer overmold structure that holds a plurality of contact beams configured to contact corresponding pads in a pluggable module. In accordance with another embodiment, the first end of the flex circuit can have a curved portion, where plated pads are formed on a first surface of the curved portion and where one or more spring beams are disposed on a second surface of the curved portion to provide a spring force for the curved portion. In accordance with another embodiment, the first end of the flex circuit may be coupled to a compression socket attached to an articulating connector structure via springs. The compression socket can be configured to contact corresponding signal and ground pads of a pluggable module. In accordance with another embodiment, the first end of the flex circuit may be coupled to a vertically-oriented compression socket attached to a fixed connector support structure via springs.

The flex circuit can be configured to communicatively couple a port connector to one or more integrated circuits or processors mounted on the host PCB. Coupling a port connector to other components on the host PCB via one or more flex circuits in these ways can be technically advantageous and beneficial for reducing signal loss while improving signal integrity and routing flexibility between different components in the network device.

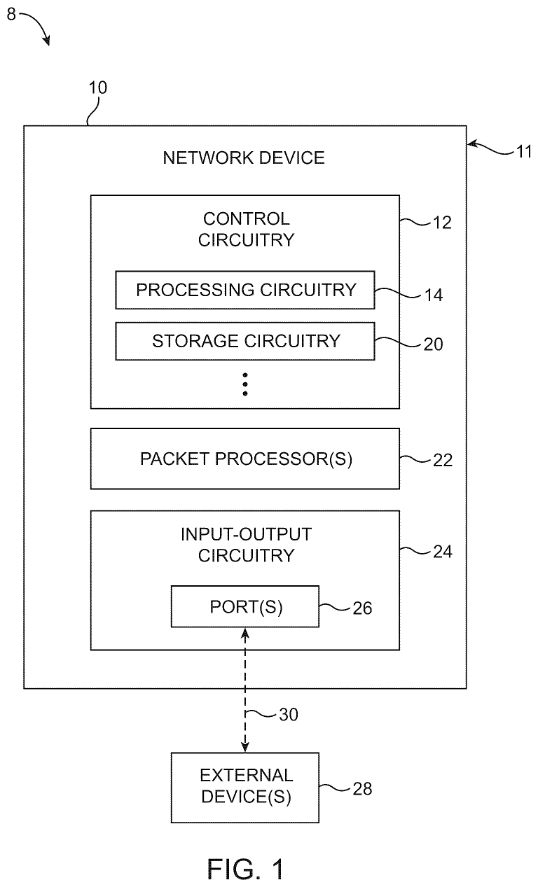

FIG. 1 is a diagram of a network device such as network device 10 that can be provided with port connectors coupled to one or more flex circuits. In the example of FIG. 1, an illustrative system 8 may include one or more network devices 10. Each network device 10 may be a switch (e.g., a single-layer (Layer 2) switch or a multi-layer (Layer 2 and Layer 3) switch), a router or gateway, a bridge, a hub, a repeater, a firewall, a wireless access point, a network management device that manages one or more other network devices, a device serving other networking functions, a device that includes a combination of these functions, or other types of network devices. Multiple such network devices 10 (e.g., of different types and/or having different functions) in system 8 may be present and interconnected therebetween and with other network devices in other network portions to form a communications network that forwards network traffic (e.g., as frames, as packets, and/or in other forms) between end hosts.

Network device 10 may include control circuitry 12 having processing circuitry 14 and storage circuitry 20, one or more packet processors 22, and input-output circuitry 24 disposed within a housing 11 of network device 10. The housing 11 may include an exterior cover (e.g., a plastic exterior shell, a metal exterior shell, or an exterior shell formed from other rigid or semi-rigid materials) that provides structural support and protection for the components of network device 10 mounted within the housing. In one illustrative arrangement, network device 10 may be part of a modular network device system (e.g., a modular switch system having removably coupled modules usable to flexibly adjust system capabilities such as adjust the network traffic processing capabilities by changing the number of processors, memory, and/or other hardware components, adjust the number of ports, add or remove specialized functionalities, etc.). In another illustrative arrangement, network device 10 may be a fixed-configuration network device (e.g., a fixed-configuration switch having a fixed number of ports and/or a fixed hardware configuration).

Processing circuitry 14 may include one or more processors or processing units based on central processing units (CPUs), graphics processing units (GPUs), microprocessors, general-purpose processors, host processors, microcontrollers, digital signal processors, programmable logic devices such as a field programmable gate array device (FPGA), application specific system processors (ASSPs), application specific integrated circuit (ASIC) processors, and/or other processor architectures. Processing circuitry 14 may run (execute) a network device operating system and/or other software/firmware that is stored on storage circuitry 20.

Storage circuitry 20 may include one or more non-transitory (tangible) computer readable storage media that stores the operating system software and/or any other software code, sometimes referred to as program instructions, software, data, instructions, or code. As an example, network device control plane functions may be stored as (software) instructions on the one or more non-transitory computer-readable storage media (e.g., in portion(s) of memory circuitry 20 in network device 10). The corresponding processing circuitry (e.g., one or more processors of processing circuitry 14 in network device 10) may process or execute the respective instructions to perform the corresponding operations. Storage circuitry 20 may be implemented using non-volatile memory (e.g., flash memory or other electrically-programmable read-only memory configured to form a solid-state drive), volatile memory (e.g., static or dynamic random-access memory), hard disk drive storage, and/or other storage circuitry. Storage circuitry 20 is therefore sometimes referred to as memory circuitry. Processing circuitry 14 and storage circuitry 20 as described above may sometimes be referred to collectively as control circuitry 12 implementing a “control plane” of network device 10.

For example, processing circuitry 14 may execute network device control plane software such as operating system software, routing policy management software, routing protocol agents or processes, routing information base agents, and other control software, may be used to support the operation of protocol clients and/or servers (e.g., to form some or all of a communications protocol stack such as the Transmission Control Protocol (TCP) and Internet Protocol (IP) stack), may be used to support the operation of packet processor(s) 22, may store packet forwarding information, may execute packet processing software, and/or may execute other software instructions that control the functions of network device 10 and the other components therein.

Packet processor(s) 22 may be used to implement a data plane or forwarding plane of network device 10. Packet processor(s) 22 may include one or more processors or processing units based on central processing units (CPUs), graphics processing units (GPUs), microprocessors, general-purpose processors, host processors, microcontrollers, digital signal processors, programmable logic devices such as a field programmable gate array device (FPGA), application specific system processors (ASSPs), application specific integrated circuit (ASIC) processors, and/or other processor architectures. Packet processor 22 may receive incoming data packets via input-output circuitry 24, parse and analyze the received data packets, process the packets based on packet forwarding decision data (e.g., data in a forwarding information base) and/or in accordance with network protocol(s) or other forwarding policy, and forward (or drop) the data packet accordingly. The packet forwarding decision data may be stored on a portion of storage circuitry 20 and/or other memory circuitry integrated as part of or separate from packet processor 22.

To interact with external devices, external systems, and/or users, network device 10 may include input-output circuitry (interface) 24 formed from corresponding input-output devices (sometimes referred to as interface circuitry). Input-output interface circuitry 24 may include different types of communication interfaces such as Ethernet interfaces (e.g., formed from one or more Ethernet ports), optical interfaces (e.g., formed from removable optical modules containing optical transceivers), Bluetooth interfaces, Wi-Fi interfaces, and/or other network interfaces for connecting device 10 to the Internet, a local area network, a wide area network, a mobile network, other network device(s) in these networks, and/or other computing equipment (e.g., end hosts, server equipment, user devices, etc.). As an example, some input-output circuitry 24 (e.g., those based on wireless communication) may be implemented using wireless communications circuitry (e.g., antennas, transceivers, radios, etc.).

As another example, some input-output circuitry 24 (e.g., those based on wired communication) may be implemented as physical ports, sometimes referred to as sockets. These physical ports may be configured to physically couple to and/or electrically connect to corresponding mating connectors of external components or equipment (e.g., pluggable optical transceiver modules). Different ports may have different form factors to accommodate different cables, different modules, different devices, or generally different external equipment. In the example of FIG. 1, input-output circuitry 24 may include one or more ports 26. Ports 26 may be physically coupled to one or more external device(s) 28. An external device 28 can have an extension module configured to be inserted or plugged into port 26 as indicated by arrow 30.

In other illustrative arrangements, one or more components such as packet processor 22 may be omitted from device 10, and device 10 may generally be a computing device with other non-networking functions. In other words, port 26 may be contained within a non-networking computing device 10 or generally a computing or electronic system that conveys electrical signals using port 26 with external equipment.

Configurations in which ports 26 include port connectors configured to receive and mate with an edge card connector of a transceiver module are sometimes described herein as an example. In other illustrative examples, ports 26 may include any type of port connectors configured to mate with edge card connectors for other components (e.g., components utilizing Peripheral Component Interconnect (PCI) connectors, Peripheral Component Interconnect Express (PCIe) connectors, accelerated graphics port (AGP) connectors, Ethernet connectors, Thunderbolt connectors, high-definition multimedia interface connectors, etc.), and/or other types of port connectors configured to mate with non-edge-card connectors.

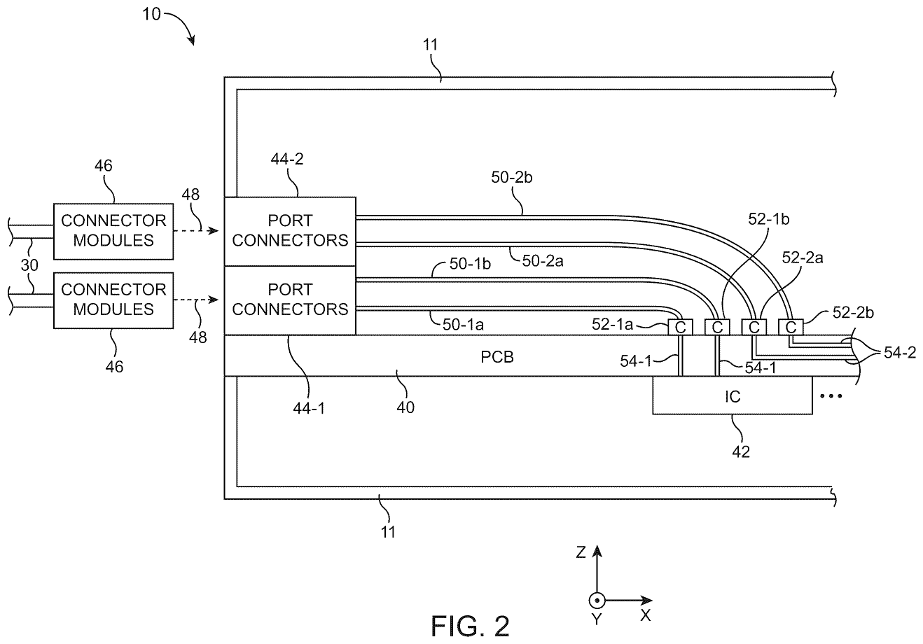

FIG. 2 is a side view of an illustrative network device 10 that has port connectors such as port connectors 44 coupled to corresponding board connectors 52 via respective flex circuits 50 in accordance with some embodiments. As shown in FIG. 2, network device 10 may include a printed circuit board (PCB) such as printed circuit board 40, an integrated circuit (IC) such as integrated circuit 42, input-output port connectors such as port connectors 44 (e.g., port connectors 44-1 and 44-2), and flex circuits such as flex circuits 50 (e.g., flex circuits 50-1a, 50-1b, 50-2a, and 50-2b). These various components can be disposed within exterior housing 11 of network device 10. Printed circuit board 40 is sometimes referred to as a main (host) board or a main (host) PCB.

One or more first port connectors 44-1 can be mounted to a first side (surface) of host PCB 40, and one or more second port connectors 44-2 can optionally be mounted (stacked) on top of first port connectors 44-1. Arranged in this way, first port connectors 44-1 can provide a first row of port connectors, whereas second port connectors 44-2 can provide a second row of port connectors. The example of FIG. 2 in which port connectors 44-2 are disposed on top of port connectors 44-1 over the first (upper) side of host PCB 40 is illustrative. If desired, additional port connectors 44 can be mounted to a second side (surface), opposing the first side, of host PCB 40. If desired, additional port connectors 44 can optionally be disposed on top of port connectors 44-2.

The various port connectors 44 can be configured to mate with or receive external connector modules 46, as shown by arrows 48. These external connector modules 46 may include (electrical or optical) transceiver modules such as pluggable or removable transceiver modules (e.g., small form-factor pluggable (SFP) modules, quad small form-factor pluggable (QSFP) modules, QSFP double density (QSFP-DD) modules, octal small form-factor pluggable (OSFP) modules, etc.) or other network interface modules, may include removable network modules that expand the functionalities of network device 10 (e.g., an asynchronous transfer mode network module, an Ethernet network module, a router or virtual private network module, a network services module, a route processor module, etc.), or may include any other suitable connector modules. External connectors modules 46 are therefore sometimes referred to herein as “pluggable” connector modules.

As an example, an optical or electrical transceiver module, when plugged into or received in port connectors 44, may enable network device 10 to be coupled to another network device 10 through a (high-speed) fiber-optic cable or a (high-speed) copper cable 30. These examples are illustrative. If desired, external connector modules 46 can include other types of backplane connectors, including but not limited to: Versa Module Europa (VME) connectors, compact Peripheral Component Interconnect (PCI) or compact PCI Express connectors, Small Computer System Interface (SCSI) connectors, Advanced Telecom Computing Architecture (ATCA) connectors, Virtual Path Cross-Connector (VPX) connectors, or a combination of these connectors, just to name a few.

In accordance with some embodiments, port connectors 44 can be communicatively coupled to board connectors 52 via one or more flex circuits 50. In the example of FIG. 2, port connectors 44-1 can be coupled to board connector 52-1a via a first flex circuit 50-1a and further coupled to board connector 52-1b via flex circuit 50-1b. Similarly, port connectors 44-2 can be coupled to board connector 52-2a via a first flex circuit 50-2a and further coupled to board connector 52-2b via flex circuit 50-2b. The board connectors 52 are sometimes referred to as host board connections. Board connectors 52 can include connectors that are soldered to the surface of host PCB 40, compression components with an appropriate landing pattern, flexible printed circuit (FPC) connectors, edge connectors, and/or other types of board connections. The board connectors 52 can be positioned (located) away from the housing of port connectors 44.

The flex circuits 50 can be referred to as flex (flexible) substrates, flex (flexible) PCBs, flex (flexible) layers, flex (flexible) interconnects, and flex (flexible) wiring boards, just to name a few. In the example of FIG. 2, each flex circuit 50 has a first end coupled to one of the board connectors 52 and has a second end that extends into one of the port connectors 44.

In accordance with an embodiment, integrated circuit 42 can be mounted to a second side (surface) of host PCB 40 via an array of solder balls (e.g., a ball grid array) or other surface-mount mechanism. Integrated circuit (IC) 42 can be an integrated circuit die or an integrated circuit package (e.g., an integrated circuit chip mounted on a package substrate within a package housing) and can generally represent one or more processors within device 10, such as a packet processor or a central processing unit (as examples). Integrated circuit (IC die or package) 42 may be communicatively (communicably) coupled to at least some of the port connectors 44 through conductive board vias and one or more flex circuits. In the example of FIG. 2, integrated circuit 42 can be coupled to the first row of port connectors within port connectors 44-1 through host board via 54-1, board connector 52-1a, and flex circuit 50-1a. Similarly, integrated circuit 42 can be coupled to the second row of port connectors within port connectors 44-1 through host board via 54-1, board connector 52-1b, and flex circuit 50-1b.

The example of FIG. 2 in which flex circuits 50-1a and 50-1b are coupled to integrated circuit 42 mounted on the opposing (e.g., lower) surface of host PCB 40, directly facing board connections 52-1a and 52-1b is illustrative. In general, any number of components can be disposed on the first (upper) surface of host PCB 40. Similarly, any number of components can be disposed on the second (lower) surface of host PCB 40. In general, at least some of the port connectors 44 can be communicatively coupled to one or more components disposed on the upper side and/or the lower side of host PCB 40. For instance, port connectors 44-2 can be coupled to one or more other components mounted on host PCB 40 through flex circuits 50-2a and 50-2b, which are connected to board connectors 52-2a and 52-2b, respectively, and through signal traces 54-2 formed within host PCB 40. Signal traces 54-2 are sometimes referred to as host board interconnect pathways or PCB interconnects. Connecting port connectors 44 to other components mounted on host PCB 40 using one or more flex circuits 50 in this way is technically advantageous and beneficial to reduce signal loss while improving signal integrity and routing flexibility between different components within network device 10.

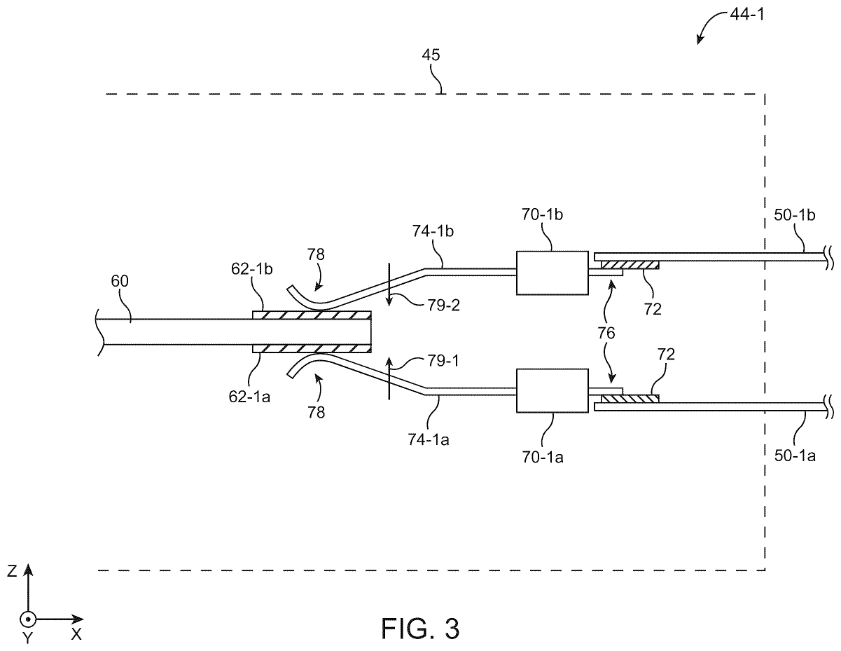

In accordance with an embodiment, the flex circuits 50 can be configured to electrically contact a corresponding external connector module 46 using contact beams (see, e.g., FIG. 3). As shown in the side view of FIG. 3, flex circuits 50-1a and 50-1b can extend into a port connector housing 45 of a port connector 44-1. Flex circuit 50-1a can be coupled to a first plurality of contact beams 74-1a via respective flex circuit connections 72. The flex circuit connections 72 can include plated pads for forming brazed (soldered) contacts, laser-welded connections, ultrasonic-welded connections, thermal and/or pressure bonded connections, conductive adhesives, mechanical fastening or crimping mechanisms, a combination of these connections, and/or other ways of making metal connections.

The plurality of contact beams 74-1a can be held together using a contact beams support structure 70-1a. Contact beams support structure 70-1a can, for example, be an overmolded structure formed using an overmolding process. As examples, contact beams support structure 70-1a can be formed using plastic, polymer, elastomer, rubber, a combination of these materials, and/or other insulating overmolding material(s). The plurality of contact beams 74-1a can be metallic contact beams formed using copper or copper alloys, silver or silver alloys, gold or gold alloys, tungsten or tungsten alloys, nickel or nickel alloys, palladium or palladium alloys, a combination of these materials, and/or other suitable conductive material. The plurality of contact beams 74-1a can have a first distal portion 76 that protrudes from support structure 70-1a and that is coupled to flex circuit connections 72.

The plurality of contact beams 74-1a can have a second distal portion 78 that is curved to receive a corresponding mating portion of an external (pluggable) connector module 46. In particular, FIG. 3 shows a connector board 60 that can be part of external connector module 46 that is inserted within housing 45 of port connector 44-1. Connector board 60 can alternatively represent a layer that is fixed within port connector housing 45. Device configurations in which connector board 60 is part of the pluggable connector module 46, which can be removably detached or unplugged from housing 45, are sometimes described herein as an example. In general, one or more components can be mounted on connector board 60 and communicatively coupled to flex circuits 50 via one or more intervening connections.

Board contacts 62 can be formed on the surface(s) of connector board 60 for contacting corresponding contact beams 74-1a. Board contacts 62 can represent plated pads (e.g., an array of exposed areas of metal), edge connectors (e.g., exposed conductive strips located along an edge of connector board 60), or other types of exposed contacts. In the example of FIG. 3, the plurality of contact beams 74-1a can be electrically coupled to connector module 46 via board contacts 62-1a disposed on the lower surface (side) of connector board 60. In particular, curved portion 78 may apply an upward spring force (as illustrated by the direction of arrow 79-1) to ensure proper electrical connection with contacts 62-1a when module 46 is inserted within connector housing 45. Connector board 60 configured in this way is sometimes referred to as an “edge card” or a paddle card.

Similarly, flex circuit 50-1b can be coupled to a second plurality of contact beams 74-1b via respective flex circuit connections 72 (e.g., plated pads for forming brazed (soldered) contacts, laser-welded connections, ultrasonic-welded connections, thermal and/or pressure bonded connections, conductive adhesives, mechanical fastening or crimping mechanisms, a combination of these connections, etc.). The plurality of contact beams 74-1b can be held together using another contact beams support structure 70-1b. Contact beams support structure 70-1b can, as described above, be an overmolded structure formed using an overmolding process (e.g., a support structure formed using plastic, polymer, elastomer, rubber, a combination of these materials, and/or other insulating overmolding material(s)). The plurality of contact beams 74-1b can be metallic contact beams formed using copper or copper alloys, silver or silver alloys, gold or gold alloys, tungsten or tungsten alloys, nickel or nickel alloys, palladium or palladium alloys, a combination of these materials, and/or other suitable conductive material. The plurality of contact beams 74-1b can have a first distal portion 76 that protrudes from support structure 70-1b and that is coupled to flex circuit connections 72.

The plurality of contact beams 74-1b can have a second distal portion 78 that is curved to receive connector board 60. Additional board contacts such as contacts 62-1b can be disposed on the upper surface (side) of connector board 60. In the example of FIG. 3, the plurality of contact beams 74-1b can be electrically coupled to connector module 46 via board contacts 62-1b. In particular, curved portion 78 of contact beams 74-1b may apply a downward spring force (as illustrated by the direction of arrow 79-2) to ensure proper electrical connection with contacts 62-1b when module 46 is inserted within connector housing 45. Configured in this way, edge card 60 can provide a double-sided connection (e.g., on both upper and lower surfaces of board 60 with at least two separate flex circuits 50-1a and 50-1b) to maximize connectivity in a limited amount of space.

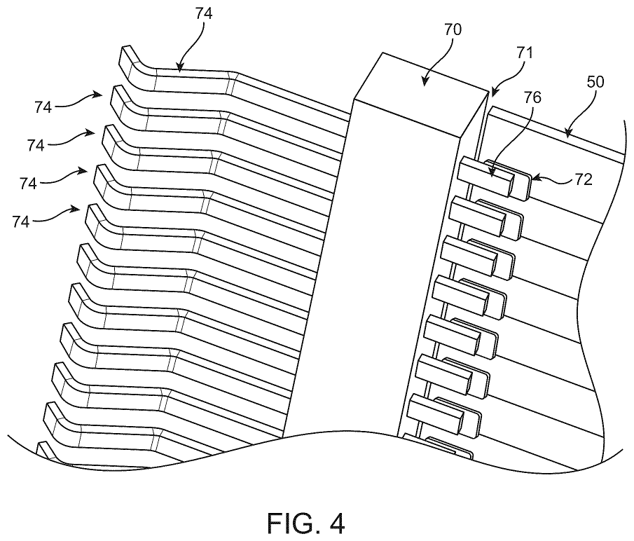

FIG. 4 is a bottom perspective view of illustrative contact beams 74 coupled to flex circuit 50. As shown in FIG. 4, contact beams 74 can be arranged as parallel contact beams that extend through contact beams support structure 70. The first distal ends 76 of the parallel contact beams 74 can be electrically coupled to respective flex circuit connections 72 disposed on the surface of flex circuit 50. Flex circuit 50 can be physically separated from contact beams support structure 70 by a gap 71. This is exemplary. If desired, flex circuit 50 can optionally be touching support structure 70 (e.g., without any gap 71).

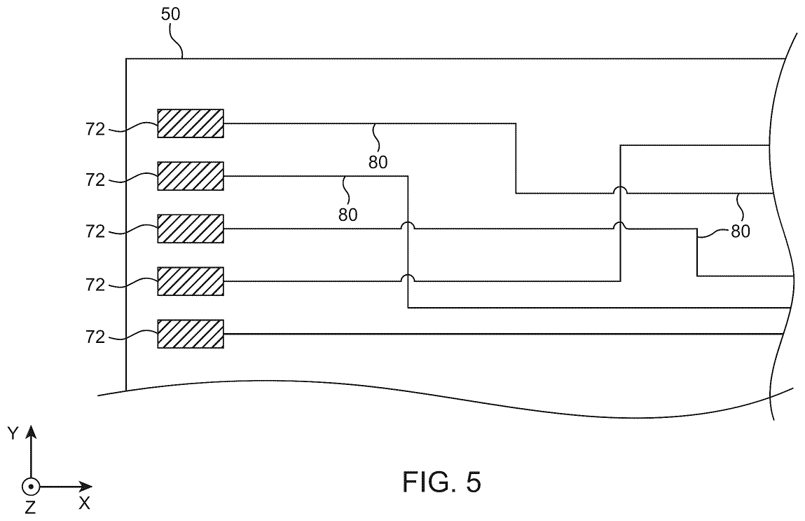

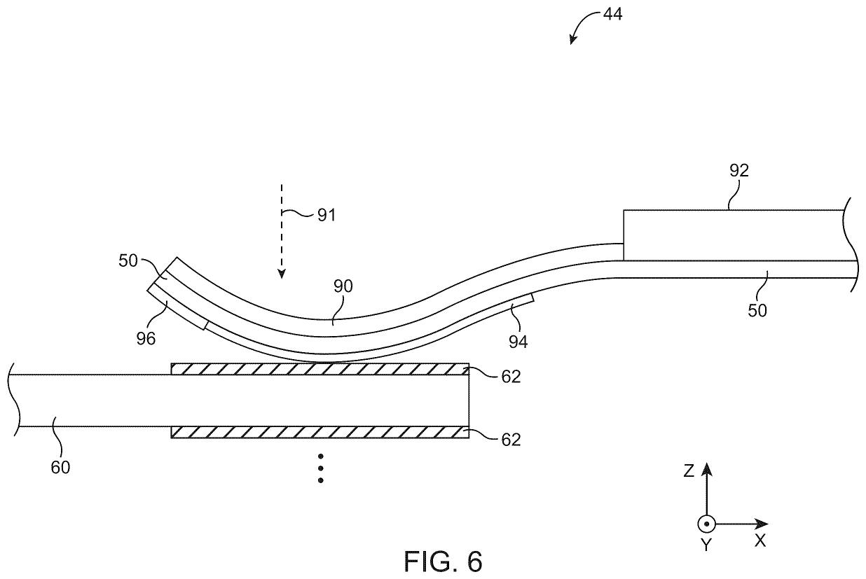

In general, flex circuit 50 can include a plurality of electrical pathways. FIG. 5 is a top (plan) view of flex circuit 50. As shown in FIG. 5, a row (linear array) of flex circuit connections 72 can be formed along a peripheral edge of flex circuit 50. As described above in connection with FIGS. 3 and 4, the edge connections 72 can be soldered, welded, or otherwise joined with distal end 76 of corresponding contact beams 74. Flex circuit 50 shown in FIG. 5 is not limited to the embodiments of FIGS. 3 and 4 but can also be used in the embodiments of FIGS. 6-10.

The edge connections 72 can be connected to respective electrical (signal) pathways 80 formed in or on flex circuit 50. Pathways 80 can be formed as conductive traces (e.g., signal traces, power traces, grounding traces, shielding traces, etc.) in a flexible substrate of flex circuit 50. Flex circuit 50 can generally include one or more flexible substrate layers. Traces 80 can be formed in the same layer or different layers in flex circuit 50. Traces 80 can optionally be routed over one another, as shown in the example of FIG. 5, to provide routing flexibility. Traces 80 can primarily extend along the X direction, but can optionally have segments (portions) that extend parallel to the Y direction. The different segments running along the X direction and along the Y direction can form 90 degree (perpendicular) turns in flex circuit 50. This is also exemplary. If desired, each trace 80 can optionally exhibit one or more turns at any angle. Traces 80 can sometimes be referred to herein as flex circuit traces or flex circuit interconnects.

The embodiment described above in connection with FIGS. 3 and 4 in which flex circuit 50 contacts an external (pluggable) connector module 46 via a plurality of contact beams is exemplary. FIG. 6 shows another embodiment in which flex circuit 50 is configured to directly contact connector board 60. Connector board 60 can be part of external connector module 46 that is inserted within a port connector 44. Board contacts such as board contacts 62 can be formed on one or more surfaces of connector board 60. Board contacts 62 can represent plated pads (e.g., an array of exposed areas of metal), edge connectors (e.g., exposed conductive strips located along an edge of connector board 60), or other types of exposed contacts.

As shown in FIG. 6, flex circuit 50 can have a curved distal portion that extends directly over board contacts 62 when the external connector module is inserted within port connector 44. Flex circuit contacts 94 can be formed on a given surface of flex circuit 50 facing board contacts 62. Flex circuit contacts 94 can be plated pads, edge connectors, or other types of exposed contacts. If desired, a protective layer 96 can be provided at the tip of flex circuit 50 on the given surface of flex circuit 50. Protective layer 96 can, for example, be a solder mask that is raised above the flex circuit contacts 94 to protect flex circuit contacts 94 during insertion of the edge card (e.g., protective layer 96 may have a thickness that is greater than the thickness of flex circuit contacts 94).

One or more spring beams 90 can be disposed on the other surface, opposing the given surface, of flex circuit 50. Spring beams 90 can overlap the curved distal portion of flex circuit 50. Spring beam 90s can be configured to apply a downward spring force (as shown by the direction of arrow 91) to ensure that flex circuit contacts 94 are properly mated with corresponding board contacts 62. Spring beams 90 can be curved metal beams configured only to provide the downward spring force 91 without any electrical functionality. As such, spring beams 90 should be electrically insulated from the flex circuit contacts 94. The spring beams 90 can be separate parallel spring members or can optionally be merged into a contiguous spring sheet have the curved profile as shown in the side view of FIG. 6.

The one or more spring beams 90 can be held together using a spring beams support structure 92. Spring beams support structure 92 can, for example, be an overmolded structure formed using an overmolding process. As examples, spring beams support structure 92 can be formed using plastic, polymer, elastomer, rubber, a combination of these materials, and/or other insulating overmolding material(s). Relative to the embodiment of FIG. 3 in which flex circuit 50 is connected to the edge card via intervening connections 72 and contact beams 78, the embodiment of FIG. 6 can eliminate connections 72 between contact beams 78 and flex circuit 50, which can be technically advantageous and beneficial to improve signal integrity. Although FIG. 6 shows only one flex circuit 50 being coupled to board contacts 62 on the upper surface of connector board 60, an additional flex circuit can optionally be coupled to board contacts 62 on the lower surface of connector board 60 using a similar spring beam(s) mechanism (e.g., by mirroring the flex circuit assembly shown in FIG. 6).

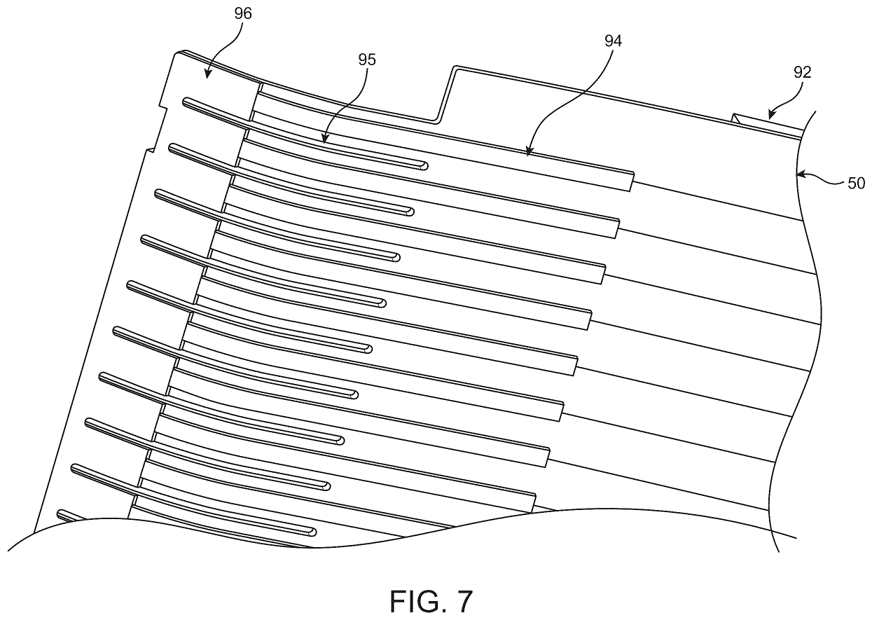

FIG. 7 is a bottom perspective view of the illustrative flex circuit assembly of the type described in connection with FIG. 6. As shown in FIG. 7, flex circuit contacts 94 can be parallel strips of conductive material formed on the underside of flex circuit 50. Slits such as slits 95 can be formed between adjacent flex circuit contacts 94 in the flex circuit 50 to provide more flexibility in each contact 94 (e.g., to enhance the ability of flex circuit 50 to bend or flex reliably without breaking when being subjected to repeated insertions or removals of the edge card). Slits 95 can be referred to as elongated flex circuit openings or flex circuit channels.

Configured in this way, the plurality of flex circuit contacts 94 can sometimes be considered to be formed on respective distal “fingers” or end portions of flex circuit 50. In the example of FIG. 7, protective layer 96 is shown as one continuous layer covering the tips of the various flex circuit fingers. A continuous protective layer 96 can provide additional mechanical support for the plurality of fingers. This is illustrative. If desired, the tips of the various distal fingers of flex circuit 50 need not be physically connected (e.g., the fingertips can be separated by air gaps), where the tip of each finger is covered by a small piece of protective layer (mask) 96. Spring beam(s) support structure 92 can be disposed on the other side (surface) of flex circuit 50. Flex circuit 50 of FIG. 7 can include a plurality of flex circuit interconnects of the type described in connection with FIG. 5.

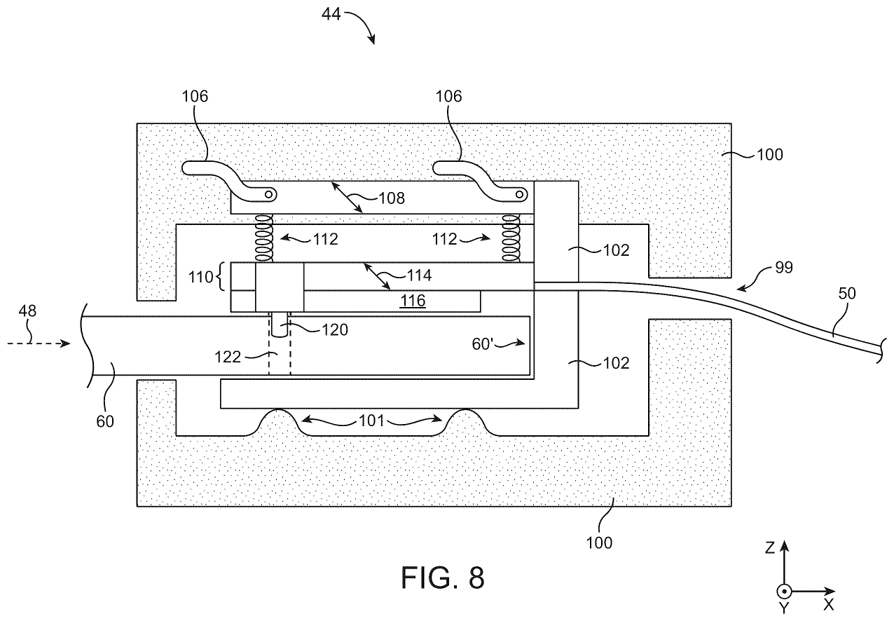

The embodiments described in connection with FIGS. 3, 4, 6, and 7 in which a flex circuit 50 is electrically coupled to an edge card of a pluggable (removable) connector module 46 are exemplary. FIG. 8 shows another embodiment of a port connector 44 in which flex circuit 50 is electrically coupled to connector board 60 via a compression socket. Connector board 60, sometimes referred to as an edge/paddle card, can be part of an external connector module 46 (see FIG. 2) that is inserted within port connector 44. As shown in FIG. 8, port connector 44 may have a connector housing 100. Connector housing 100 may be fixed within network device 10 (see FIG. 1) and is thus sometimes referred to as a “non-movable” connector housing. Flex circuit 50 can extend through an opening such as opening 99 of connector housing 100.

Flex circuit 50 can be coupled to a printed circuit board (PCB) such as a rigid PCB 110. Rigid PCB 110 can be attached to a connector portion such as articulating connector portion 102 within connector housing 100. Articulating connector portion 102 can be attached to connector housing 100 via one or more cams 106. The cams 106 can have a shape that allows articulating connector portion 102 to move in the direction of arrows 108. Since rigid PCB 110 is attached to connector portion 102, the rigid PCB 110 can also move in the direction of arrows 114 as the connector portion 102 articulates within the non-movable connector housing 100. Connector portion 102 configured to articulate in this way within the fixed connector housing 100 is sometimes referred to as a “movable” connector portion. In particular, the movable connector portion 102 can be coupled to rigid PCB 110 via one or more springs 112. The use of springs 112 is exemplary. If desired, other ways of providing a compressive force on rigid PCB 110 as connector portion 102 articulates within connector housing 100 can be employed.

Rigid PCB 110 can also be coupled to a compression socket such as compression socket 116. Compression socket 116 can refer to and be defined herein as a type of electrical connector that creates a strong, reliable electrical connection via mechanical compression fitting without the use of soldering. Since no soldering is used, such mechanical connection can be readily installed and removed without sacrificing durability and reliability. In the example of FIG. 8, the one or more springs 112 can be attached to a first (upper) surface of rigid PCB 110, whereas compression socket 116 can be attached to a second (lower) surface of rigid PCB 110. Furthermore, an alignment pin such as alignment pin 120 can be coupled to rigid PCB 110.

Prior to insertion of connector board 60 within connector housing 100, movable connector portion 102 can be in a raised position, sometimes referred to as an “unengaged” position. Upon insertion of connector board 60 into connector housing 100 (as shown in the direction of arrow 48), the tip portion 60′ of the edge card can push against the movable connector portion 102, which then causes connector portion 102 to move downwards from the raised (unengaged) position into a lowered position, sometimes referred to herein as an “engaged” position. Connector portion 102 will reach the fully engaged position when it rests on housing portions 101 of connector housing 100, as shown in the snapshot of FIG. 8. In the engaged (lowered) position, springs 112 will apply a downward force that causes compression socket 116 to establish electrical contact with connector board 60. Springs 112 operable to provide a downward compression force on compression socket 116 in this way are thus sometimes referred to as “socket loading” spring or compression members. Moreover, alignment pin 120 can be inserted into a corresponding alignment pin opening (hole) 122 in connector board 60 to ensure proper alignment in the engaged position. Although only a single alignment pin 120 is shown in FIG. 8, more than one alignment pin 120 can be employed to ensure proper alignment in the XY plane.

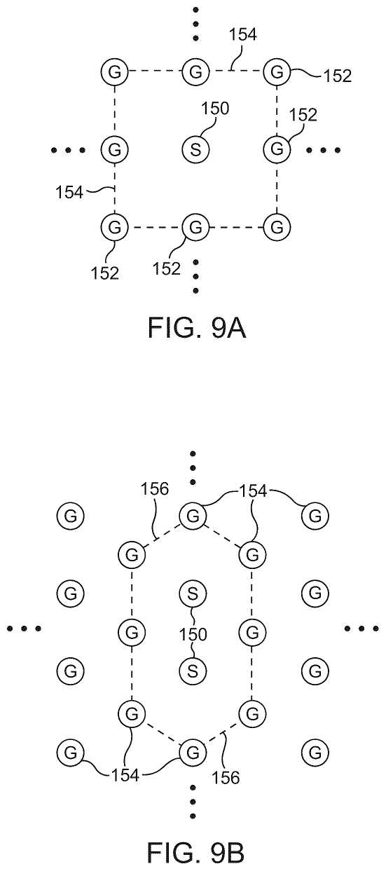

Connector board 60 can have a plurality of exposed contacts on its surface for electrically contacting compression socket 116 in the engaged position. FIG. 9A is a top (plan) view of illustrative signal and ground contacts arranged in a rectangular pattern on the surface of connector board 60. As shown in FIG. 9A, a signal contact 150 can be at least partially surrounded by ground contacts 152. If desired, the ground contacts 152 can optionally be shorted by ground traces 154 to form a continuous rectangular grounding path that completely surrounds signal contact 150. FIG. 9B is a top (plan) view of illustrative signal and ground contacts arranged in a hexagonal pattern on the surface of connector board 60. As shown in FIG. 9B, a group of at least two adjacent signal contacts 150 can be at least partially surrounded by ground contacts 154. If desired, the ground contacts 154 can optionally be shorted by ground traces 156 to form a continuous hexagonal grounding path that completely surrounds the pair of signal contacts 150. The example of FIG. 9A in which two signal contacts 150 are surrounded by ground contacts 154 is illustrative. In general, groups of two or more signal contacts 150 can be at least partially or completely surrounded by grounding paths of any suitable shape.

The examples of FIGS. 9A and 9B in which one or more signal contact(s) 150 are surrounded by a rectangular or hexagonal ground path are illustrative. In other embodiments, one or more adjacent signal contact(s) 150 can be surrounded or shielded by ground paths forming a ring (e.g., circular) shape, an oval (e.g., elliptical) shape, a pentagonal shape, a shape with curved and/or straight edges, or other shape. In general, signal and ground contacts (e.g., exposed contacts) of any pattern can be formed on the surface of connector board 60.

Compression socket 116 can have a corresponding signal and ground contacts pattern that matches the contacts pattern on the surface of board 60. As examples, compression socket 116 can include spring pins, anisotropic conductive materials, flat metal contacts, serrated contacts (e.g., contacts with serrated or ridged surfaces to provide a better grip), or other types of electrical contacts configured to provide a stable electrical connection for compression-type fittings.

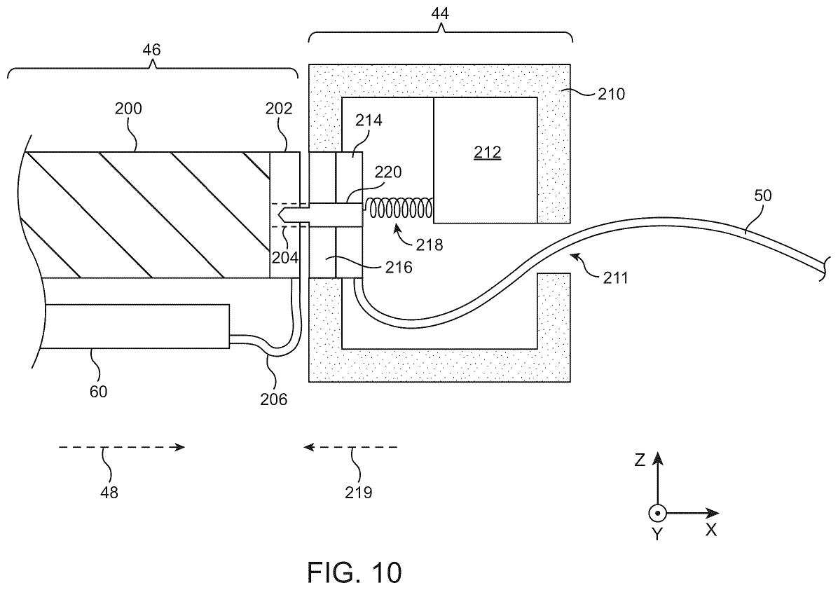

The example of FIG. 8 in which port connector 44 includes a compression socket 116 configured to electrically contact connector board 60 in accordance with a compressive force applied along the Z direction is illustrative. FIG. 10 shows another embodiment of port connector 44 having a compression socket configured to electrically contact a corresponding external/pluggable connector module 46 in accordance with a compressive force applied along the X direction. As shown in FIG. 10, port connector 44 may have a connector housing 210. Connector housing 210 may be fixed within network device 10 (see FIG. 1). Flex circuit 50 can extend through an opening such as opening 211 of connector housing 210.

Flex circuit 50 can be coupled to a printed circuit board (PCB) such as a rigid PCB 214. Rigid PCB 214 can be attached to a connector support structure 212. In particular, rigid PCB 214 can be coupled to support structure 212 110 via one or more springs 218. The use of springs 218 is exemplary. If desired, other ways of providing a compressive force on rigid PCB 214 can be employed. Rigid PCB 214 can also be coupled to a compression socket such as compression socket 216. Compression socket 216 can refer to and be defined herein as a type of electrical connector that creates a strong, reliable electrical connection via mechanical compression fitting without the use of soldering. Since no soldering is used, such mechanical connection can be readily installed and removed without sacrificing durability and reliability. In the example of FIG. 10, the one or more springs 218 can be attached to a first (right) surface of rigid PCB 214, whereas compression socket 216 can be attached to a second (left) surface of rigid PCB 214. Furthermore, an alignment pin such as alignment pin 220 can be coupled to rigid PCB 214.

The external pluggable connector module 46 can be mated with or received by port connector 44. Upon insertion of connector module 46 against connector housing 210 (as shown in the direction of arrow 48), a rigid PCB 202 of module 46 can directly contact compression socket 216. Rigid PCB 202 can be coupled to a support structure 200 within module 46. In this mated state, springs 218 will apply a lateral force in the direction of arrow 219 that causes compression socket 216 to establish an electrical connection with corresponding exposed contacts on the surface of rigid PCB 202. The direction 219 of the compression force is thus parallel to the surface normal of compression socket 216 (e.g., orthogonal to the surface on which exposed contacts are formed). In other words, the direction 219 of the compressive force is also parallel to the insertion direction 48 as module 46 is plugged into port connector 44. Springs 218 operable in this way to push against compression socket 216 are thus sometimes referred to as “socket loading” spring or compression members. Moreover, alignment pin 220 can be inserted into a corresponding alignment pin opening (hole) 204 in rigid PCB 202 60 to ensure proper alignment in the mated position. Although only a single alignment pin 220 is shown in FIG. 10, more than one alignment pin 120 can be employed to ensure proper alignment in the YZ plane.

Rigid PCB 202 can be electrically coupled to connector board 60 via a flex circuit 206. One or more components can be mounted on connector board 60 and communicatively coupled to rigid PCB 202 via flex circuit 206. Rigid PCB 202 can have a plurality of exposed contacts on its surface for electrically contacting compression socket 216 in the mated position (see, e.g., signal and ground contacts pattern as shown and described above in connection with FIGS. 9A and 9B). The examples of FIGS. 9A and 9B in which one or more signal contact(s) 150 are surrounded by a rectangular or hexagonal ground path are illustrative. In other embodiments, one or more adjacent signal contact(s) 150 can be surrounded or shielded by ground paths forming a ring (e.g., circular) shape, an oval (e.g., elliptical) shape, a pentagonal shape, a shape with curved and/or straight edges, or other shape. In general, signal and ground contacts (e.g., exposed contacts) of any pattern can be formed on the surface of rigid PCB 202. Compression socket 216 can have a corresponding signal and ground contacts pattern that matches the contacts pattern on the surface of rigid PCB 202. As examples, compression socket 216 can include spring pins, anisotropic conductive materials, flat metal contacts, serrated contacts (e.g., contacts with serrated or ridged surfaces to provide a better grip), or other types of electrical contacts configured to provide a stable electrical connection for compression-type fittings.

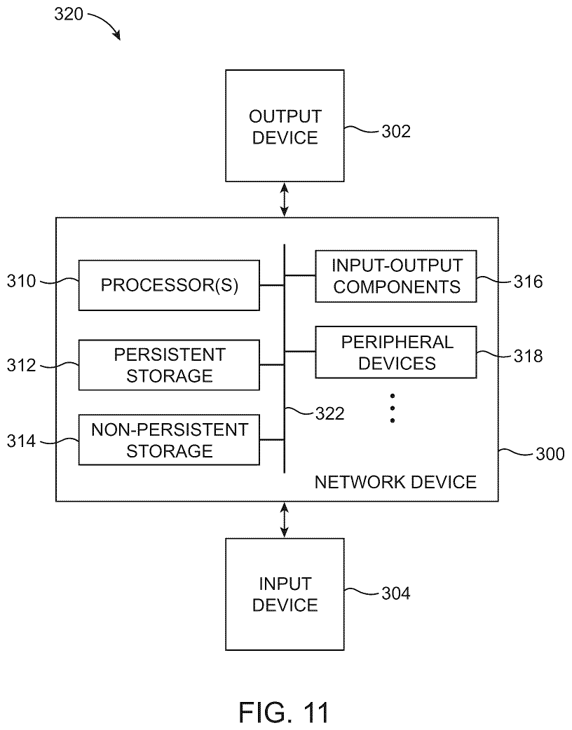

The foregoing embodiments may be made part of a larger system. FIG. 11 shows a system such as data processing system 320. Data processing system 320 may include a network device 300 optionally coupled to an input device 304 and/or an output device 302. Network device 300 may represent a network device 10 described in connection with the embodiments of FIGS. 1-10. Network device 300 may include one or more processors 310 (e.g., processing circuitry 14 of FIG. 1), storage circuitry such as persistent storage 312 (e.g., flash memory or other electrically-programmable read-only memory configured to form a solid-state drive, a hard disk drive, etc.), non-persistent storage 314 (e.g., volatile memory such as static or dynamic random-access memory, cache memory, etc.), or any suitable type of computer-readable media for storing data, software, program code, or instructions, input-output components 316 (e.g., communication interface components such as a Bluetooth® interface, a Wi-Fi® interface, an Ethernet interface, an optical interface, and/or other networking interfaces for connecting device 300 to the Internet, a local area network, a wide area network, a mobile network, other types of networks, and/or to another network device), peripheral devices 318, and/or other electronic components. These components can be coupled together via a system bus 322.

As an example, network device 300 can be part of a host device that is coupled to one or more output devices 302 and/or to one or more input devices 304. Input device(s) 304 may include one or more touchscreens, keyboards, mice, microphones, touchpads, electronic pens, joysticks, buttons, sensors, or any other type of input devices. Output device(s) 302 may include one or more displays, printers, speakers, status indicators, external storage, or any other type of output devices.

System 320 may be part of a digital system or a hybrid system that includes both digital and analog subsystems. System 320 may be used in a wide variety of applications as part of a larger computing system, which may include but is not limited to: a datacenter, a financial system, an e-commerce system, a web hosting system, a social media system, a healthcare/hospital system, a computer networking system, a data networking system, a digital signal processing system, an energy/utility management system, an industrial automation system, a supply chain management system, a customer relationship management system, a graphics processing system, a video processing system, a computer vision processing system, a cellular base station, a virtual reality or augmented reality system, a network functions virtualization platform, an artificial neural network, an autonomous driving system, a combination of at least some of these systems, and/or other suitable types of computing systems.

The methods and operations described above in connection with FIGS. 1-11 may be performed by the components of a network device using software, firmware, and/or hardware (e.g., dedicated circuitry or hardware). Software code for performing these operations may be stored on non-transitory computer readable storage media (e.g., tangible computer readable storage media) stored on one or more of the components of the network device. The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of the network device (e.g., processor 14 and/or processor 22 of FIG. 1, processor 310 of FIG. 11, etc.).

The foregoing is merely illustrative and various modifications can be made to the described embodiments. The foregoing embodiments may be implemented individually or in any combination.

What is claimed is:

1. A network device comprising:
a host printed circuit board;
a first board connector disposed on a first surface of the host printed circuit board;
a port connector disposed on the first surface of the host printed circuit board, wherein the port connector is configured to receive an external connector module; and
a first flex circuit having a first end coupled to the first board connector and having a second end that extends into the port connector.

2. The network device of claim 1, further comprising:
an integrated circuit die disposed on a second surface, opposing the first surface, of the host printed circuit board and coupled to the first board connector through one or more conductive vias in the host printed circuit board.

3. The network device of claim 1, further comprising:
a second board connector disposed on the first surface of the host printed circuit board; and
a second flex circuit having a first end coupled to the second board connector and having a second end that extends into the port connector.

4. The network device of claim 1, wherein the first flex circuit comprises:
a curved portion at the second end; and
a plurality of flex circuit contacts disposed on a first surface of the first flex circuit in the curved portion and configured to electrically contact corresponding contacts of the external connector module.

5. The network device of claim 4, further comprising:
one or more spring beams disposed on a second surface, opposing the first surface, of the first flex circuit in the curved portion, wherein the one or more spring beams are configured to apply a spring force that presses the plurality of flex circuit contacts against the contacts of the external connector module.

6. The network device of claim 5, further comprising:
a spring beams support structure disposed on the second surface of the first flex circuit and configured to hold the one or more spring beams in place on the first flex circuit.

7. The network device of claim 4, wherein the first flex circuit further comprises a plurality of slits, each of which is interposed between an adjacent pair of flex circuit contacts in the plurality of flex circuit contacts.

8. The network device of claim 4, wherein the first flex circuit further comprises a protective layer disposed along a tip of the curved portion and configured to provide protection for the plurality of flex circuit contacts.

9. The network device of claim 1, further comprising:
a plurality of contact beams having a first end coupled to the first flex circuit via respective flex circuit connections and having a second end that is curved and configured to electrically contact corresponding contacts of the external connector module.

10. The network device of claim 9, further comprising:
a contact beams support structure configured to hold the plurality of contact beams in place.

11. The network device of claim 1, wherein the port connector comprises:
a rigid printed circuit board coupled to the second end of the first flex circuit; and
a compression socket disposed on the rigid printed circuit board and configured to electrically contact corresponding contacts of the external connector module.

12. The network device of claim 1, wherein the port connector is configured to receive pluggable modules including one or more of: small form-factor pluggable (SFP) modules, quad small form-factor pluggable (QSFP) modules, QSFP double density module (QSFP-DD) modules, and octal small form-factor pluggable (OSFP) modules.

13. The network device of claim 1, wherein the port connector is configured to receive external modules including one or more of: Versa Module Europa (VME) connectors, compact Peripheral Component Interconnect (PCI) connectors, compact PCI Express connectors, Small Computer System Interface (SCSI) connectors, Advanced Telecom Computing Architecture (ATCA) connectors, and Virtual Path Cross-Connector (VPX) connectors.

14. A network device comprising:
a host printed circuit board;
a board connector disposed on the host printed circuit board;
a port connector disposed on the host printed circuit board, wherein the port connector is configured to receive an external connector module; and
a flex circuit having a first end coupled to the board connector and having a second end coupled to a movable connector portion of the port connector.

15. The network device of claim 14, wherein the movable connector portion is configured to articulate between a first position when the external connector module is unplugged from the port connector and a second position, different than the first position, when the external connector module is plugged into the port connector.

16. The network device of claim 14, wherein the port connector further comprises:
a rigid printed circuit board coupled to the movable connector portion;
a compression socket disposed on a first surface of the rigid printed circuit board and configured to electrically contact corresponding contacts of the external connector module; and
one or more springs disposed between the movable connector portion and a second surface, opposing the first surface, of the rigid printed circuit board.

17. The network device of claim 16, wherein the port connector further comprises:
one or more alignment pins coupled to the rigid printed circuit board and configured to extend into corresponding alignment holes in an edge card of the external connector module.

18. A network device comprising:
a host printed circuit board;
a board connector disposed on the host printed circuit board;
a port connector disposed on the host printed circuit board, wherein the port connector is configured to receive an external connector module; and
a flex circuit having a first end coupled to the board connector and having a second end electrically coupled to a compression socket in the port connector.

19. The network device of claim 18, wherein the port connector further comprises:
a rigid printed circuit board disposed between the compression socket and the second end of the flex circuit; and
one or more springs configured to apply a compressive force on the rigid printed circuit board.

20. The network device of claim 19, wherein the external connector module is inserted into the port connector along a given direction, and wherein the one or more springs is configured to apply the compressive force in a direction that is parallel to the given direction.
